(19) United States
(12) Patent Application Publication
(10) Pub. No.: US 2010/0154221 A1
(43) Pub. Date: Jun. 24, 2010

(54) Inclined razor blades sloping on X and/or Z axis

(76) Inventors: Mauro De Benedetto, Castello di Godego (TV) (IT); Dino Gnesotto, Castello di Godego (TV) (IT)

Correspondence Address: JACOBSON HOLMAN PLLC, 400 SEVENTH STREET N.W., SUITE 600, WASHINGTON, DC, 20004, US

(21) Appl. No.: 12/591,908

(22) Filed: Dec. 4, 2009

Related U.S. Application Data
(63) Continuation-in-part of application No. PCT/IT2009/000134, filed on Apr. 8, 2009.

(30) Foreign Application Priority Data
Apr. 11, 2008 (IT) TV2008 A000055

(51) Int. Cl. B26B 21/22; B26B 21/52

(52) U.S. Cl. 30/48; 30/50; 30/527

(57) ABSTRACT

Multi blade razors having at least three blades for cutting the beard and/or unnecessary hairs. The razor is equipped with inclined and/or sloping blades. The inclination is a single inclination on one axis and possibly multiple inclinations in various axes. This allows implementation of a blade cut with consequent improvement of smoothness on the skin. The inclined blades are orientated on two axes to dissect the hair bringing the hair to the sharpened side without forcing the hair to be cut violently. The lifetime of the blade is improved, with a cutting capacity which is clearly superior to a razor extending perpendicular to a handle. The use of less than three inclined blades could be dangerous for the skin and might produce uncomfortable shaving, if utilized by non-professional barbers or untrained end-users.

This is a continuation-in-part of PCT/IT2009/000134 filed Apr. 8, 2009 and published in English, which has a priority of Italian application no. TV2008 A000055 filed Apr. 11, 2008, hereby incorporated by reference.

### FIELD OF THE INVENTION

The present invention relates to multi blade razors with at least three inclined blades for the shaving of the beard and/or unnecessary hairs. These razors are equipped with inclined and/or sloping blades with regards to the razor handle; the inclination being a single inclination on one axis or multiple inclinations on more axes. This invention allows to increase the effectiveness of the blade cut with the consequent improvement in the smoothness of the skin. The inclination of the blades on two axes reduces the stress on the skin, as the cut takes place gently, concentrating the force of the blades in an inclined manner on the molecular binding of the hairs. By the present invention, the cutting of the hair is accomplished without adversely affecting the external layer (epidermis) because the cutting is carried out by at least three blades. Three blades are able to reduce the shear pressure per square inch, in a way that the inclination will not be dangerous to the skin, at the specific inclination.

### BACKGROUND OF THE INVENTION

In the past, a single blade razor was used which was referred to as a “flick razor”. Only the careful hand of a professional barber knew how to correctly use the inclination of the razor without cutting the skin of the customer. The inclination of the tool was provided by the expert hand of the operator.

Later on, the razor evolved for everybody, to the so-called “safety razor” with a replaceable blade. The safety razor consisted of a razor with a handle and a blade support. Only the blade was replaced periodically. “Safety razors” have always been produced and marketed with the feature of having the blade positioned at 90° with respect to the handle.

Later, disposable razors were produced and marketed. Disposable razors included one or more blades, with the feature of having the blade or the blade cartridge (depending on the number of blades installed in the cartridge) positioned at 90° with respect to the razor handle.

The current state of the art allows industrial production of multi-blade razors with features of repeatable accuracy. Therefore, the realization of a razor blade with inclined blades with regards to the handle, in total safety for the end user, is now possible.

In the field of manual razors, such as disposable or regenerable razors with new sets of blades, the blade has always been placed at 90° with respect to the razor handle and has only a downward inclination of a few degrees of the blades only towards the frontal part to be cut, as shown in FIG. 1a and 1b. From one blade, there has been a progression of blades to two blades in series, then three blades, then four blades, then five connected blades, to try to shave the beard more easily, also with the help of a vibration device. One is therefore producing cutting instruments which are more and more expensive, where the increase in multiple cutting blades affects the shaving cost.

Regarding blade lubrication and friction reduction on the skin, one has applied strips of material that release lubricating film. Regarding the inclination of the blade on the hair to be cut, this field has not acquired such an efficient evolution or revolution, except for vibration as mentioned above. In spite of the techniques available, the present condition of the technique used adversely affects the external layer of the skin (thickness reduction of the epidermis), caused by frontal cutting stress.

Despite the various razor blade assemblies used in the past, an uncomfortable and perhaps sometimes dangerous shaving event has resulted. It is therefore an object of the present invention to avoid the problems encountered by the single razor blade assemblies of the past.

In the past, an inclined razor was never produced because an inclination with a single blade was unsafe for the integrity of the skin of the end-user. One blade presents a high pressure per square inch and in most cases shaving was unpleasant, if not dangerous. Shaving was too risky for the end-user skin to safely self-operating a sharp “sword.”

It is therefore an object of the present invention to use at least three blades for improving the shaving quality without risks, avoiding practical problems encountered and unsolved by single razor blade assemblies of the past.

### SUMMARY OF THE INVENTION

The present invention, as shown in FIGS. 2a and 2b, consists of inclining the blades with respect to the razor handle, therefore the blade head is no longer orthogonal as is the prior technique. The inclined blades are orientated on two axes, taking advantage of the molecular separation, dissecting the hair and bringing the hair to the sharpened side without forcing the hair to be roughly cut. In practical terms, one obtains the same effect produced by the famous guillotine cutting blade, with its particular shape of blade.

The inclined application is possible by using a minimum of three blades to reduce a specific cutting pressure, therefore safely using the razor without cutting the skin. All of the advantages given by the inclination of the blades with respect to the handle remain, which is the subject of the claimed innovation.

The inclined blades thus permit a more efficient shaving that is smooth. The implementation of the present system, is therefore possible by inclining the blades in various ways and no longer maintaining the blades orthogonal with regards to the support handle.

With the blades inclined with respect to the razor handle one allows the cutting residue to come out easier from the cutting area, always maintaining the cutting tool clean. The fact that the blades are inclined, allows the residue to self-canalize more easily in the exit direction. The inclined blade does not want to completely replace the horizontal orthogonal, which is more suitable for the precise cut of the sideburns and if one wishes to use a perpendicular blade, a perpendicular blade is placed behind the inclined blades (see FIGS. 7-8).

It is therefore an object of the present invention to take advantage of at least three blades to produce an at least three blade razor, where it is possible to have the at least three blades inclined with safe and comfortable shaving, with specified tolerances of inclination of the at least three blades in the X and Z axes.

The inclination of the blades can be a single inclination on the X axis with an inclination that varies from 0.1° to ±30° (see FIGS. 3 and 4). The inclination of the blades can also be a double inclination, when the at least three blades are rotated not only on the X axis but also on the Z axis from 0.1° to ±15° with regards to the supporting axis located in the handle (see FIGS. 9 and 10). The blades with a double inclination allow a more efficient shaving against the growth of the moustache, on the chin and where the blades need a minor cutting area, as the surface to be shaved is not completely flat but curved and/or inclined.

1. Technical characteristics of the solution: A sharpened set of at least three blades is fundamental for a good cut. The thinner the cutting edges, the greater the cutting pressure that one is able to produce on the cutting object. The cutting pressure (P) is given by the force applied perpendicularly on the area (F^{⊥}) divided by the surface of the application area (A), therefore:

$$P = \frac{{F}^{⊥}}{A} \qquad ( 1 )$$

At least three sharpened blades permit minimization of the application area A in order to maximize the cutting pressure. Just cutting pressure is not sufficient for a good cut. It is a common experience that if one lets the blade knife slide on the object to be cut, one obtains a cut that is easier and more precise (example: bread and/or salami cut). This is because applying a cutting stress is more efficient in separating the molecules one from the other, rather than applying a single cutting pressure on the same, seeing that by doing this one concentrates the stress on the single molecular bindings instead of compressing an entire row. Therefore, the shear T is equal to the force applied parallel to the plane F// divided by the application plane surface A:

$$T = \frac{F //}{A} \qquad ( 2 )$$

Also in this case, a sharpened blade allows to minimize the application area in order to maximize the cutting stress of the cut made.

To summarize, the cutting stress permits to break the molecular bindings in an easier way, while the pressure permits advancement in the cutting object through the breaking line of the molecular bindings.

When examining the guillotine cut which is maybe the closest example to the innovation, where in place of free fall, the traction of the hand that moves the cutting tool is used. Regarding the application of the double inclination, keeping the above equations valid, a cutting tool is obtained that on an undulated and/or inclined surface, is able with its own small area of contact to solve the defect that the typical 90° blade with support is unable to follow a face profile and/or the human body; to connect to what is described above, in the conditions of shaving against the growth of moustache, chin and area under the lower lip, a superior cutting capacity is achieved and only referring to the area that must be cut. In this case, an optimization of cut of the cutting tool has been carried out in more critical areas.

2. Property of the innovation: Better shaving with a same number of blades. Extended lifetime of the blades. Minor inflammation and cuts that usually come from excessive cutting force. Easier shaving, without having to insist too much in carrying out the shave against the growth. Less painful and better shaves, especially with coarse beards and/or hairs. Better evacuation of the cut residue (shaving cream and cut hairs), as the same has the possibility to flow out, having an easier exit.
3. Economic innovation: Increased lifetime of the blades, which is remarkably superior to a 90° blade, with a cutting capacity which is clearly superior with the same number of blades. The application of the single or multiple inclination is simple; thus having brought the number of tools to an acceptable level and therefore the cost of the complete cut is reduced by the incidence of the blades on the cuts made.
4. Innovation: Allows to take advantage of the existing shaving technologies, by bringing the single or multiple inclination of the cutting blades of the beard and/or unnecessary hairs, by increasing the capacity and quality of cut of the existing razors, without having to necessarily increase the number of the blades. The inclined blades can assume different combinations of structures as shown in FIGS. 3, 4, 5 and 6.
5. Practical Realization of the inclination: The achievement of the single or double inclination is obtained in various and simple ways. It is possible to pre-mould inclined razors or place the blades on releasable swivel supports; that is, for the inclination of the blades on the X axis one places a release mechanism behind the blades and therefore the user decides how many degrees one wishes to place the blades between the value of 0.1° to ±30° on the axis of the razor handle. The Z rotation can always take place by means of a release rotating mechanism, with which one can rotate the blades from 0.1° to ±15°. It is necessary to confirm that even the rotation of the blades on the Z axis can be pre-fixed on the plastic mould of the same support.
6. Application field: In the instruments fitted for the cutting of beards and hairs, in the field of razors in general, of those of a single blade, of the disposable and/or regenerable with new blades, thus being able to develop the cutting capacity of the razors without having to further increase the number of the blades.

These and other objects of the invention, as well as many of the intended advantages thereof, will become more readily apparent when reference is made to the following description taken in conjunction with the accompanying drawings.

### BRIEF DESCRIPTION OF THE DRAWINGS

The following drawings illustrate examples of various components of the invention disclosed herein, and are for illustrative purposes only. Other embodiments that are substantially similar can use other components that have a different appearance.

FIG. 1a illustrates the shaving motion of a prior art razor.

FIG. 1b illustrates a prior art razor with the blades extending perpendicular to the handle of the razor.

FIG. 2a illustrates the initial shaving with a razor according to the present invention.

FIG. 2b illustrates the path cut from a beard using the razor of the present invention.

FIG. 3 illustrates the angle through which the razor head may be rotated in the X axis with respect to the handle of the razor of the present invention.

FIG. 4 illustrates the rotation of the razor head with respect to the handle in a direction opposite to that shown in FIG. 3.

FIG. 5 shows two sets of razor blades of the invention mounted on a T-shaped handle in an inverted V configuration.

FIG. 6 illustrates the mounting of two sets of multiple razor blades of the invention on a handle with the two sets of blades inclined in a V-shaped configuration.

FIG. 7 illustrates a front view of a razor having two sets of multiple blades inclined with respect to each other in a V-shaped configuration and interconnected by another set of multiple blades extending perpendicular to the handle.

FIG. 8 is an opposite view to that of FIG. 7 to illustrate the third set of multiple blades extending perpendicular to the handle and interconnecting the two sets of multiple blades in a V-shaped configuration.

FIG. 9 illustrates the tilting of a set of razor blades with respect to a Z axis.

FIG. 10 is a side view of the razor shown in FIG. 9 to illustrate the tilting of the set of multiple blades tilted with respect to the X and Z axes.

FIG. 11 schematically illustrates the forces used by the razor of the present invention.

FIGS. 12a-12d illustrate the application of the principle of the present invention to a razor, it being understood that, although a single razor blade is depicted, according to the present invention, there are at least three razor blades.

FIG. 13 is a perspective view of the razor of the present invention illustrating a mechanism used to tilt the razor blades with respect to the handle of the razor.

FIG. 14 is a front view of the razor shown in FIG. 13 with a curved intersecting line of two portions of the handle of the razor to illustrate the path of curvature of the razor blades with respect to the handle upon actuation of an adjustment mechanism.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

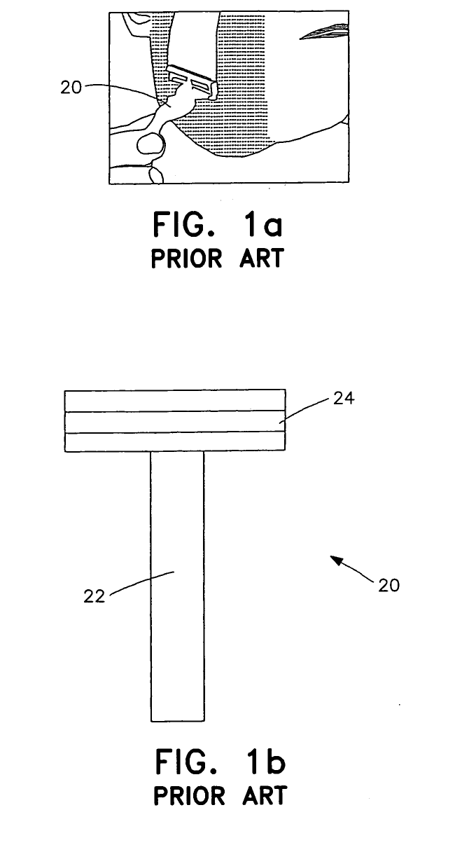

In FIGS. 1a and 1b, traditional use of a razor 20 is shown. The razor includes a handle 22 having a blade 24 mounted at one end of the handle. The blade 24 extends perpendicular to the handle.

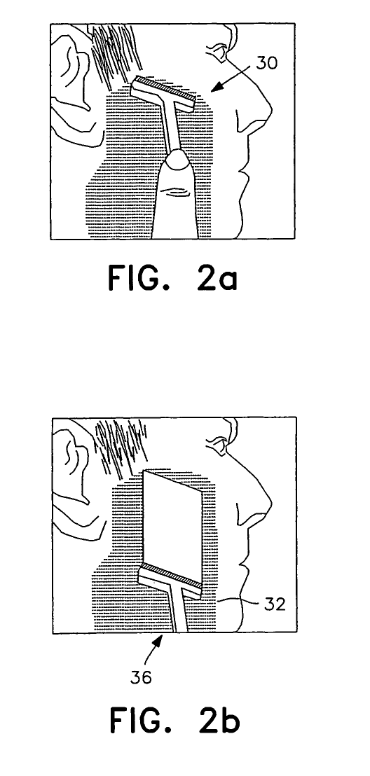

In contrast, the razor 30 of the present invention, is shown in FIGS. 2a and 2b. The path drawn across the face 32 of an individual causes the at least three blades of the razor to cut a path extending at an angle (other than perpendicular) to the handle.

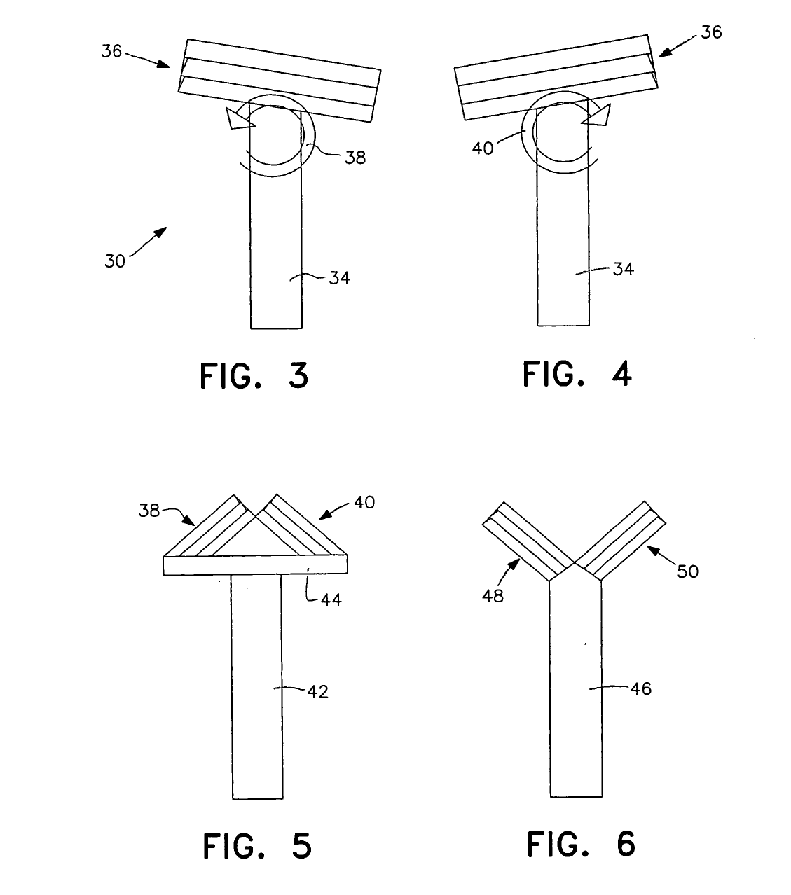

As shown in FIGS. 3 and 4, the razor 30 includes a handle 34 and at least three blades 36. For ease of description, the at least three blades will be referenced as “a set of blades”.

As shown in FIG. 3, the set of blades 36 is rotatable from the position shown in the figure in the direction of arrow 38 in a direction of the X axis so as to approach but not achieve an angle extending perpendicular to the handle 34. In FIG. 4, the set of blades 36 is rotatable in a direction of arrow 40 to approach but not achieve an angle extending perpendicular to the handle 34.

Other examples of sets of blades, for example sets of blades 38 and 40 as shown in FIG. 5, are aligned to extend from handle 42 having perpendicular post 44 so that the sets of blades 38, 40 are in an inverted V-shaped configuration. Either blade set 38 or 40 may be used for shaving.

Similarly, in FIG. 6, the sets of blades 48, 50 extend from handle 46 in a V-shaped configuration. Either blade set may be used for shaving.

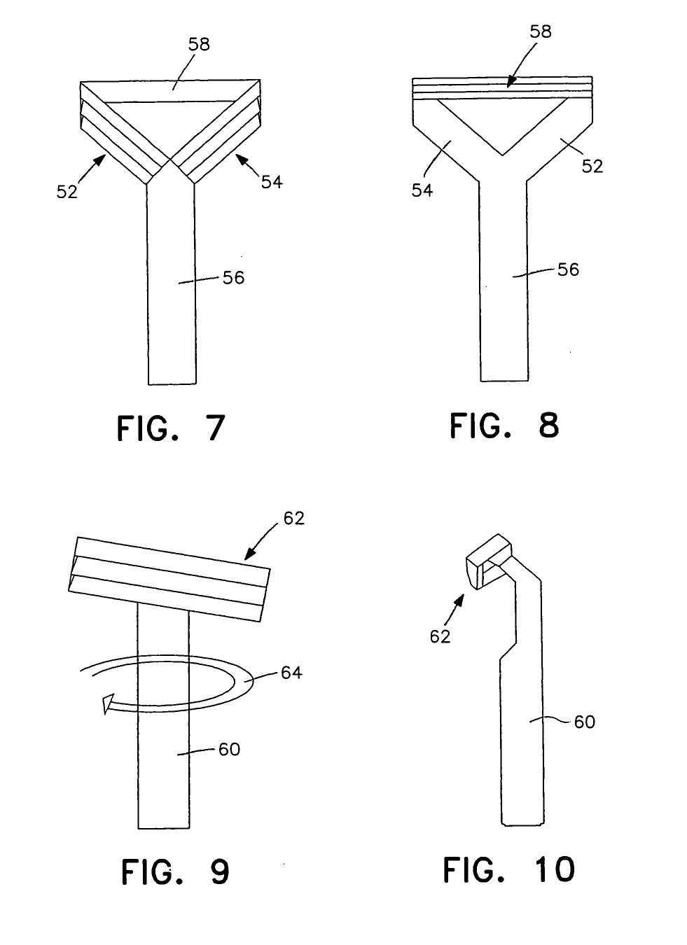

In FIGS. 7 and 8, the sets of blades 52, 54 extend in a V-shaped configuration with respect to handle 56. A connector bridge 58 is shown in FIG. 7. In FIG. 8, from a reverse view with respect to FIG. 7, the connector bridge forms a set of blades which extend perpendicular to handle 56 as was previously known. This configuration allows implementation of the angled sets of blades with respect to the handle, other than perpendicular, and also allows use of a perpendicular extending set of blades 58.

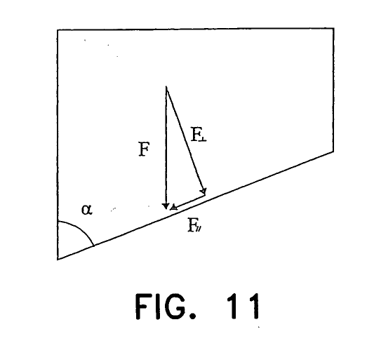

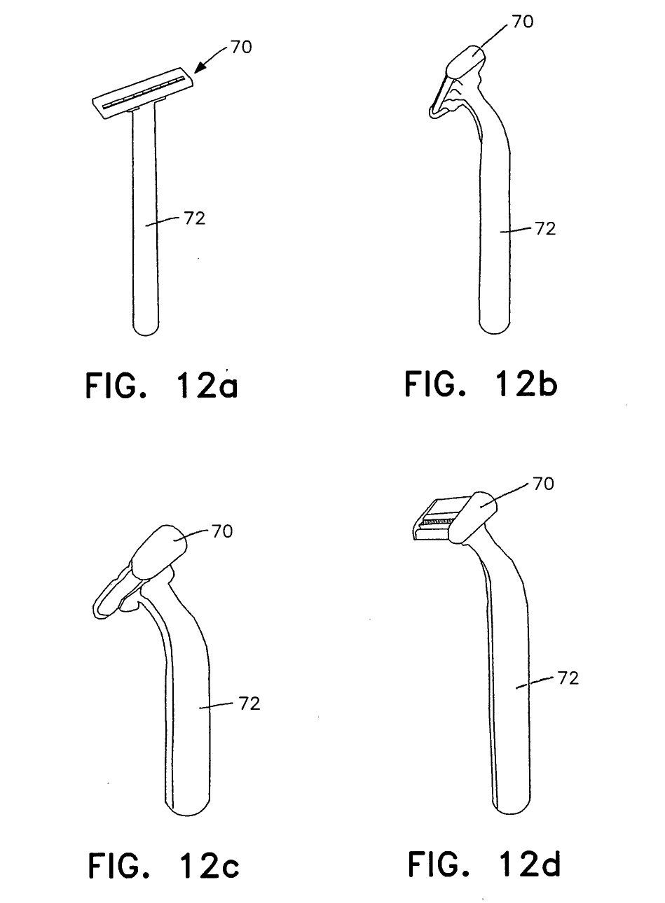

In FIGS. 9 and 10, in addition to the tilting of the sets of blades in the X axis with respect to handle 60, the sets of blades 62 are also tilted with respect to the Z axis as shown by arrow 64. Not only do the sets of blades tilt with respect to the X axis at an angle other than perpendicular and up to 30 degrees with respect to the handle 60, but the sets of blades 62 are also tilted in the Z axis at an angle up to 15 degrees. As better shown in FIG. 10, a variation on the cutting angle of the set of blades 62 is encountered when contacting the face of a user.

In FIG. 11, one can see the guillotine blade schematically shown with force lines and the characteristic trapezoidal shape. The guillotine acts from the top to the bottom, moved by its own strength weight F=mg, where m is the mass of the blades, plus a possible weight placed above it, and g is the acceleration of gravity. Thanks to the particular shape of this type of blade this F force can be divided into two components (in FIG. 11) with regards to the system of the two Cartesian axes, given by the cutting edge of the blades and by the perpendicular component of the same on the level of the blades. Therefore F//=F cos α to the component parallel to the cutting edge of the blades and F=F sin α, the perpendicular component to the cutting edge of the blades.

In this way it is possible to use a simple movement, just like that of free fall, to apply to the cutting object both cutting pressure and cutting stress, keeping equations (1) and (2) valid.

In FIGS. 12a-12d, examples of the sets of blades 70 tilted with respect to a handle 72 is shown from various views to demonstrate the tilting in both the X and Z axes.

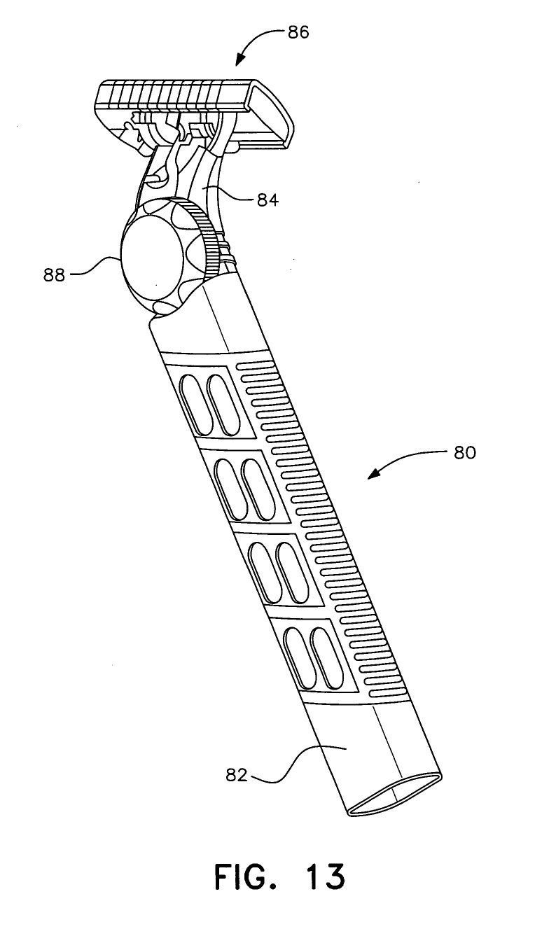

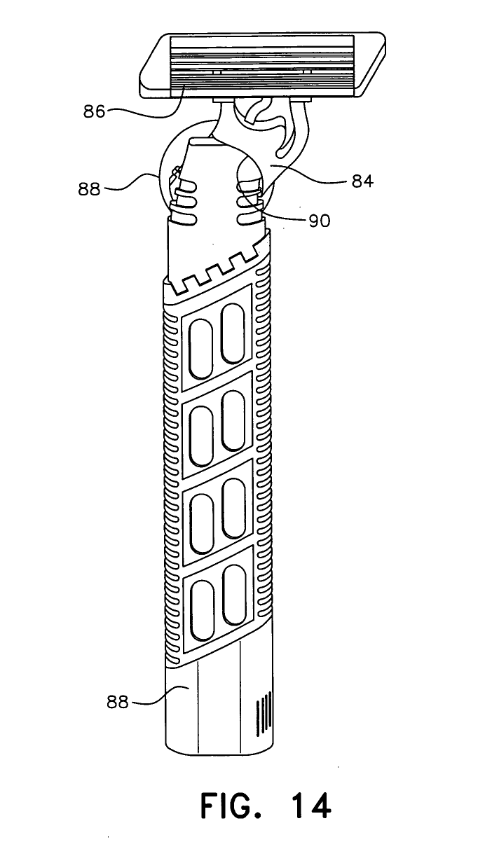

In FIG. 13, a handle 80 is divided into a lower section 82 and an upper section 84. The set of blades 86 is mounted on the upper section 84. An adjustment wheel 88 is shown interconnecting the lower section 82 and the upper section 84.

As shown in detail in FIG. 14, by adjustment of the wheel 88, the upper section is moved with respect to the lower section of the handle, moving along split line 90 so as to guide the movement of the set of blades 86 with respect to the lower portion 82 of the handle 80. The adjustment may be made and maintained by the adjustment wheel 88 so as to position the set of blades offset from the X and Z axes of the handle to achieve the desired results of the present invention.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

We claim:

1. A razor comprising
a handle having X, Y and Z axes,
a longitudinal axis of the handle being coincident with the Y axis, and
at least three blades mounted on the handle, the at least three blades having an adjustable inclination for use in cutting of a beard and hair, and
an adjustability of the at least three blades being with respect to the X and Z axes.

2. The razor as claimed in claim 1, wherein the at least three blades are sloping and/or adjustable blades.

3. The razor as claimed in claim 1, wherein there are two sets of at least three blades extending in a V-configuration with respect to each other.

4. The razor as claimed in claim 1, wherein there are two sets of at least three blades extending in an inverted V-configuration.

5. The razor as claimed in claim 1, wherein the at least three blades are adjustable in the Z axis at an angle of 0.1°±15°.

6. The razor as claimed in claim 5, wherein the at least three blades are fixed at the angle with respect to the Y axis.

7. The razor as claimed in claim 5, wherein the adjustment of the at least three blades is in opposite directions with respect to the handle.

8. The razor as claimed in claim 1, wherein the at least three blades are adjustable in the X axis at an angle of 0.1±30°.

9. The razor as claimed in claim 8, wherein the at least three blades are adjustable in the Z axis at an angle of 0.1°±15°.
